(19) United States
(12) Patent Application Publication
(10) Pub. No.: US 2006/0091148 A1
(43) Pub. Date: May 4, 2006

(54) Dispensing device and dispensing assembly for flower vases, flower vase and method for placing flowers into a vase

(76) Inventor: Eduardo-Alexander Van Den Berg, Amsterdam (NL)

Correspondence Address: Greenberg Traurig, Suite 400E, 2450 Colorado Avenue, Santa Monica, CA, 90404, US

(21) Appl. No.: 10/541,077

(22) PCT Filed: Dec. 30, 2003
(86) PCT No.: PCT/NL03/00949

§ 371 Date: Jun. 29, 2005

(30) Foreign Application Priority Data
Dec. 31, 2002 (NL) 1022294

(51) Int. Cl. G07F 11/04

(52) U.S. Cl. 221/221; 221/93

(57) ABSTRACT

The present invention relates to an adjustable foot for setting up equipment in alignment. The adjustable foot comprises an annular element provided with an axial bore with internal screw thread. The adjustable foot furthermore comprises a shaft element provided with external screw thread matching the internal screw thread. When screwed into the bore, this shaft element can be adjusted in the axial direction with respect to the annular element by turning with respect to the annular element. The adjustable foot furthermore comprises a support part, provided on the annular element or shaft element as well as a washer. The washer and the support part are each provided with a convex respectively concave surface having essentially the same radius of curvature, such that the angle of the washer with respect to the support part can be adjusted. According to the invention the top surface of the annular element is made to slope downwards in the radially outward direction. According to the invention the adjustable foot furthermore comprises a cap with a diameter greater than that of the internal screw thread. According to a further aspect, the invention relates to a combination of an adjustable foot according to the invention, a substructure and equipment set up in alignment on said substructure, as well as an anchor bolt, wherein the equipment is anchored to the substructure by means of the anchor bolt, with the adjustable foot between them.

The present invention relates to a dispensing device for flower vases. More particularly, the present invention relates to the dispensing of flower vases, as described, for example, in WO 99/3615. This document describes a disposable vase which can be made from plastic-like or cardboard-like materials.

One particular application area for vases is in hospitals. It is traditional for patients to be offered flowers which are then placed directly into vases. However, neither the patient nor the visitors have these vases available, and consequently the nursing staff often have to provide vases. However, these vases have proven to disappear quickly, partly through breakages. Moreover, it is necessary to comply with the hygiene requirements which apply inside a hospital. This means that the vases have to thoroughly cleaned after each use, but this often does not happen, increasing the risk of the transmission of germs and bacteria.

This means that the process of providing vases and handling them is complicated in particular in hospitals and other care institutions.

This problem is solved by using the flower vase described above.

A further problem is the distribution of vases of this type. It is an object of the present invention to provide a solution to this.

This object is achieved by a dispensing device for flower vases, comprising a store for a series of nested cup-shaped flower vases, a dispensing mechanism for removing individual vases from this series and displacing said vases, and actuating means for said dispensing mechanism.

According to the present invention, the flower vases are nested in a series and individual vases are removed with a dispensing mechanism and dispensed to the user. This makes it possible to provide an ordered, organized supply, storage and delivery, which is important in locations such as hospitals. Dispensing devices of this type are already known per se for beverage holders. However, the prior art does not at any point give any suggestion that dispensing devices of this type can also be used for flower vases.

According to an advantageous embodiment of the dispensing device, the store is designed to receive two series of vases arranged next to one another, with one series being arranged so as to interact with said dispensing mechanism and conveyor means being present for displacing the other series into the position of the first series.

The invention also relates to a dispensing assembly comprising at least two of the above-descried dispensing devices. This makes it possible for various types of vases to be dispensed at a single point. The term “various types of” is to be understood as encompassing both differing dimensions and differing prints on the outside. After all, a very wide range of people are to be found in hospitals and other care institutions, and the highly changeable supply of flowers means that a choice of different vases is particularly desirable and important in order to make it acceptable to use disposable vases of this type instead of the usual vases. Each dispensing device described above can be designed with a store for one or more series of vases. The number of series of this nature may differ for each dispensing device, depending on the expected demand between two top-up periods for the device. Differences of this nature will arise in particular if relatively large numbers of dispensing devices are present, such as for example four dispensing devices. A relatively small store can be provided for the least “popular” vase, while a considerably larger store may be provided for the vase which is in greater demand and is dispensed from one of the corresponding dispensing device. This makes it possible to make optimum use of the space available.

The invention also relates to a flower vase comprising a cup-shaped holder, the base part of which comprises a diameter (b) of at least 80 mm, with a height (h) of at least 100 mm, which holder consists of a paper-like material provided on the inner side with a watertight plastic lining, while the outer side is provided with printed information based on water-based ink.

This lining comprises in particular a watertight, preferably biodegradable lining, such as biopolymer.

According to the invention, the holder consists of a paper-like material which is provided with a watertight plastic lining on the inner side. A holder of this type is particularly inexpensive to produce and is particularly suitable for use as a disposable vase. In particular there are no environmental problems associated with disposal of the holder. This means that vases of this type can be made available in a simple way and disposed of with other waste after one-off use in a hospital or other care institution, and can be used to supply energy in a non-polluting way in any incineration furnace. By sticking to the dimensions described above, it is possible to ensure that a stable vase is formed, i.e. the risk of the vase falling over on movable tables provided to patients can be minimized. The height of the holder will be selected as a function of the flowers which are used. The outside of the holder may be printed on in any desired way. Moreover, the outside may be provided with a plastic coating.

According to an advantageous embodiment of the invention, the holder is used in combination with a support part. This can be coupled to the base part of the holder and provide a foot for stabilization purposes. According to a particular embodiment of the invention, the support part, in the position of use, comprises two wall parts which are positioned at a distance from one another and each provided with an opening. This opening is always different, so that optimum support can always be provided through correct positioning.

The invention also relates to a method for placing a number of flowers in a vase, comprising the steps of providing said flowers and said vase, the step of providing said vase comprising the step of dispensing a vase as described above from a series of vases. More particularly, this method is carried out with the dispensing device described above.

Of course, this dispensing device may be designed in such a manner that visitors can purchase vases using coins or cards. There may be a more general actuating feature comprising, for example, a key, a universal pass or the like for nursing staff, so that it is possible for the care staff to remove vases without cost

The invention will be elucidated in more detail below with reference to an exemplary embodiment of the invention which is illustrated in the drawings in which:

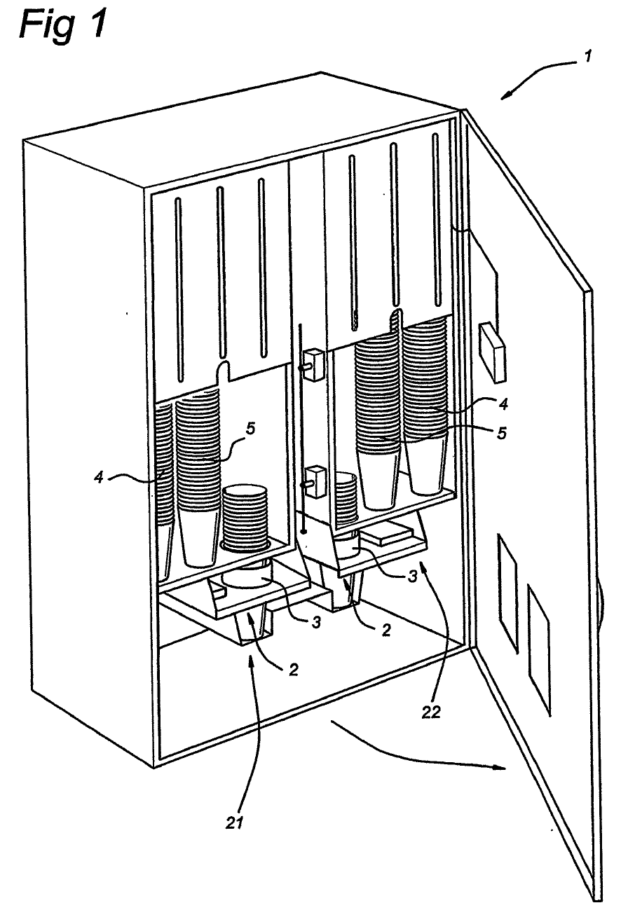

FIG. 1 diagrammatically depicts a view of a dispensing assembly according to the invention;

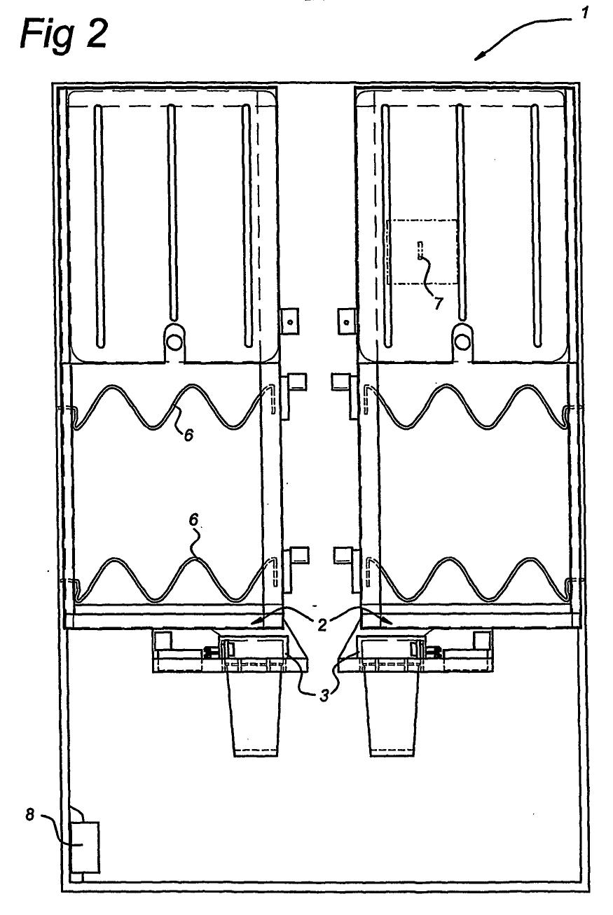

FIG. 2 shows a front view of details of the assembly shown in FIG. 1;

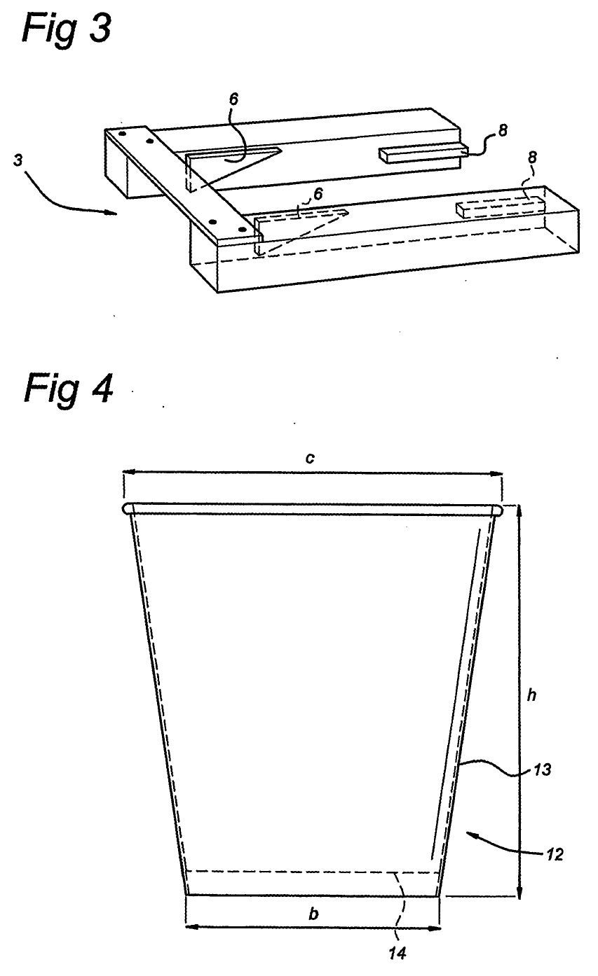

FIG. 3 shows the dispensing slide according to the present invention in detail;

FIG. 4 shows a vase in accordance with the present invention;

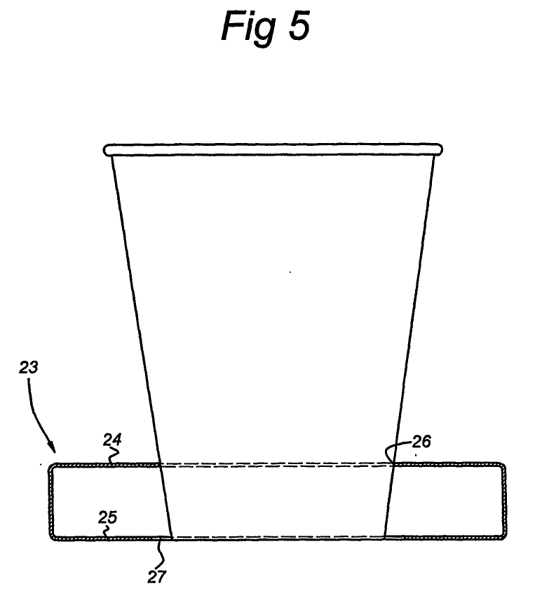

FIG. 5 shows the support part according to the invention.

In FIG. 1, a dispensing assembly for vases is denoted overall by 1. It is provided with two dispensing openings 2 (cf. also FIG. 2), from which vases are dispensed. The assembly comprises two dispensing devices, denoted by 21 and 22. Each dispensing device 21, 22 is designed to receive a series of vases denoted by 4 and 5. Series 4 interacts with a dispensing slide 3. As a result of this slide 3 being moved to and fro, the bottom two vases are separated from one another and the bottom one is moved into a position in which it can be removed. This dispensing slide 3 is moved to and fro by means of a control unit 8 which is connected, in manner which is not illustrated in more detail, to an opening 7 for the introduction of money. The introduction of a coin into opening 7 causes dispensing slide 3 to move to and fro once so that a vase is dispensed. The slide 3 is provided with carriers 8 positioned opposite one another and opposite dividers 9. In the starting position, the edge of the bottom one of series of holders bears against carriers 8 positioned opposite one another. During dispensing, the slide 3 is moved in such a manner that the carrier 8 no longer supports the bottom one of a series of holders. However, the distance between the end of the carrier 8 and the front of the divider 9 is such that the stack of holders does not drop downwards, but rather is supported by the divider 9. The divider 9 moreover engages between the bottom holder and the next holder up, with the result that the bottom holder is moved away from the next holder up and is detached. On account of the difference in vertical distance between the divider 9 and the carrier 8, the holder which is now at the bottom will be supported by the carrier 8 as the slide 3 moves back This process is repeated during the next movement of slide 3 to and fro.

When the right-hand series 4 shown in FIG. 1 is empty, the conveyor coils 6 are moved and the next series 5 is placed in position above the dispensing slide 3, and the process can be continued. By using two dispensing devices in a dispensing assembly with separate dispensing openings or a common dispensing opening, it is possible to dispense two different types of flower vases. These may be of different sizes or may be printed differently on the outside. It should be understood that with a relatively high turnover it is readily possible to use more than two dispensing devices. Four dispensing devices can be mentioned as an example. This allows two differently sized vases to be distributed, each with two different printed outer surfaces.

The above-described embodiment with more than two dispensing devices 21 and 22 can easily be realized, working on the basis of the construction shown in FIG. 1, by, for example, arranging two dispensing devices of this type over the depth of the casing of the assembly. Positioning can be implemented with a rail structure, but it is also possible for the “front one” of the dispensing devices to be hinged to the casing door or attached to the casing using any other suitable hinge structure.

FIG. 4 shows an exemplary embodiment of a vase which can be dispensed using the device shown in FIGS. 1 and 2. The vases are denoted overall by 12 and comprise a base 14 and a widening side wall 13. The base and the side wall are made from a paper-like material which is provided with a plastic lining on the inner side in order to make the holder or vase watertight. On the outside, this vase can be printed in any desired way and may comprise a further layer of plastic. The printing is preferably carried out using a water-based ink. For environmental reasons, it is preferable to use layers based on polyethylene, by way of example. A particularly thin layer is required in order to make the holder watertight. However, it is also possible to use other sealing layers. In this context consideration is given in particular to biological polymers, such as biodegradable starch polymer. The paper-like material is preferably bleached without chlorine and obtained in an environmentally friendly way. It may be recycled material. The dimensions b, c and h as shown in FIG. 4 can be selected as a function of the flowers which are to be placed into the holder and possibly also the dispensing point.

The minimum diameter b is approximately 8 cm. The minimum height is approximately 10 cm. Examples which can be given are a value of 11.5 cm for dimension b and 13.3 cm for dimension h. Dimension c is preferably at least 10 mm greater than dimension b. The diameter at the top side of the holder is preferably more than 110 mm, more particularly approximately 115 mm.

FIG. 5 shows a support part according to the present invention. This support part is denoted overall by 23 and comprises an object formed from a cardboard blank. It has two wall parts 24, 25 which are spaced apart from one another and are provided with openings 26 and 27, respectively. It can be seen from FIG. 5 that opening 26 is smaller than opening 27. This allows support part 23 to be used as a support foot for holders of different sizes. The most stable position can be found by simply turning the support part over.

On reading the above text, those skilled in the art will immediately find variants which comprise a combination of what is described in the prior art and what is described above. These variants also lie within the scope of the appended claims.

1. Dispensing device (1) for flower vases, comprising a store for a series (4, 5) of nested cup-shaped flower vases, a dispensing mechanism (3) for removing individual vases from this series and displacing these vases, and actuating means for said dispensing mechanism, which actuating means comprise a part which reacts to money or tokens.

2. Dispensing device according to claim 1, in which said store is designed to receive two series (4, 5) arranged next to one another, one series being arranged so as to interact with the said dispensing mechanism, and conveyor means (6) being provided in order to move the other series into the position of the first series.

3. Dispensing assembly comprising two dispensing devices as claimed in one of the preceding claims.

4. Dispensing assembly as claimed in claim 3, in which each of said dispensing devices is designed to handle a vase of a different size.

5. Dispensing assembly as claimed in claim 3 or 4, comprising a common dispensing opening.

6. Flower vase (1) comprising a cup-shaped holder, the base part of which comprises a diameter (b) of at least 80 mm, with a height (h) of at least 100 mm, which holder consists of a paper-like material provided on the inner side with a watertight plastic lining and provided on the outer side with printed information using water-based ink.

7. Flower vase as claimed in claim 6, in which the height of said holder is at least 120 mm.

8. Flower vase as claimed in one of claims 6 or 7, in which the external diameter of the said holder is at least 110 mm at the top.

9. Flower vase as claimed in one of claims 6-8, comprising a support part which can be releasably coupled to the base part of the said holder.

10. Flower vase as claimed in claim 9, in which the said support part comprises a double-walled part provided on two sides with an opening, with said openings being different from one another.

11. Method for placing a number of flowers in a vase, comprising the steps of providing said flowers and said vase, the step of providing said vase comprising the dispensing of a vase as claimed in one of claims 6-10 from a series of vases.

12. Method as claimed in claim 11, in which said dispensing operation comprises the step of dispensing from the dispensing device as claimed in one of claims 1-5.

13. Method as claimed in claim 12, in which said dispensing operation comprises the step of introducing money or a token into said dispensing device.
